(19) United States
(12) Patent Application Publication
(10) Pub. No.: US 2014/0191601 A1
(43) Pub. Date: Jul. 10, 2014

(54) GEARED MOTOR

(71) Applicants: Elmar Lange, Gummersbach (DE); Philipp Matuschek, Aachen (DE)

(72) Inventors: Elmar Lange, Gummersbach (DE); Philipp Matuschek, Aachen (DE)

(73) Assignee: Matuschek Messtechnik GmbH, Alsdorf (DE)

(21) Appl. No.: 14/232,430

(22) PCT Filed: Jul. 5, 2012
(86) PCT No.: PCT/EP2012/063136

§ 371 Date: Jan. 13, 2014

(30) Foreign Application Priority Data
Jul. 22, 2011 (DE) 102011079678.9

(51) Int. Cl. H02K 7/116

(52) U.S. Cl. CPC H02K 7/116
USPC 310/83

(57) ABSTRACT

A geared motor has a rotor, a stator which surrounds the rotor, and a gear mechanism with gear wheels. According to the described system, the gear wheels of the gear mechanism are arranged at least partially within the rotor. The geared motor may be provided with a switched reluctance motor as the electric drive, such that it can be used in an optimum manner for driving electric vehicles.

The invention relates to a geared motor having a rotor, a stator that surrounds the rotor and a gear mechanism having gear wheels.

In particular, the invention relates to electric motors that are embodied as geared motors and are preferably used as vehicle drives. Due to the increasing interest in electromobility, there is an increasing demand for compact, efficient and reliable electric drives for vehicles. A switched reluctance motor is a promising drive type. These motors have a simple and robust construction, are cost-effective and are maintenance free.

The object of the invention is to provide a geared motor, in particular a geared motor having a switched reluctance motor as an electric drive, which geared motor is designed so that it can be optimally used for the drive of electric vehicles.

In accordance with the invention, this object is achieved in that the gear wheels of the gear mechanism are arranged at least in part within the rotor.

The geared motor uses an optimal amount of space by virtue of the fact that the gear wheels of the gear mechanism are integrated into the interior of the rotor. In particular, reluctance motors having a high number of poles, by way of example twenty-four stator poles and eighteen rotor poles, comprise relatively large rotor diameters. However, the gear mechanism elements can also be integrated into rotors of any other electric motors in accordance with the invention. Part sections of the gear wheels can also protrude slightly beyond the dimensions of the rotor. The integration of the gear wheels into the interior of the rotor renders it possible to arrange a gear mechanism within the dimensions of the motor, which dimensions are dictated by the construction, which gear mechanism converts the motor rotation speed in a suitable manner to the rotation speeds of the output shafts of the motor, which output shafts are connected to the drive wheels of the vehicle.

As previously mentioned, the drive motor is preferably a switched reluctance motor. In a practical embodiment, this reluctance motor comprises twenty-four stator poles, which are consolidated, for example, into four pole groups each having six poles. The individual poles of the pole groups are arranged equidistant with a spacing of 60° with respect to one another. The spacing from one pole to the next pole amounts to 15°. All poles in one pole group of the stator are excited simultaneously.

The rotor does not comprise any windings and has eighteen poles. These poles are likewise arranged equidistant from one another, so that they comprise an angular spacing of 20° to the next pole. If a stator pole aligns with a rotor pole, the reluctance (the magnetic resistance) is at the lowest. The adjacent stator pole is offset with respect to the adjacent rotor pole by 5°. The subsequent stator pole is offset with respect to the subsequent rotor pole by 10°. The subsequent stator pole is offset with respect to the subsequent rotor pole by 15°. The subsequent stator pole realigns with the subsequent rotor pole and is in the same pole group as the first stator pole. A force is generated by means of rotating excitement of the stator poles, which force brings the respective adjacent lying rotor into an as optimal as possible alignment with the excited stator pole. In other words, the reluctance (magnetic resistance) is minimized. The described construction using twenty-four stator poles and eighteen rotor poles renders it possible in the case of sufficient performance to operate the motor reliably.

However, the rotor generally comprises a rotation speed that is too high for the drive axles of motor vehicles. In addition, in order to compensate for rotation speed differences in the wheels whilst negotiating curves, it is necessary to provide a differential gear for the drive shafts of a vehicle, which drive shafts drive wheels on two sides of the vehicle.

The differential gear and/or a reduction gear for adjusting the motor rotation speed to the rotation speed of the drive shafts can be integrated into the rotor in accordance with the invention.

Due to the large number of poles, the rotor has a sufficient diameter in order to accommodate the gear wheels of the gear mechanism. The poles of the rotors are generally formed as a closed ring. The ring can be formed from lamellae that are connected to one another. Eddy currents in the rotor poles are reduced or avoided by means of using lamellae to form the pole ring. Generally, the closed ring can be connected to the hub of the rotor in a positive locking manner. The hub can comprise the receiving arrangements for mounting the gear wheels. However, it is also possible to mount the gear wheels in the region of the ring having the rotor poles or to form at least one receiving arrangement for one of the gear wheels inside by means of the hub and outside by means of the pole ring. The lamellae for forming the pole ring are generally punched out of a metal sheet or cut out of a metal sheet by means of a laser. These lamellae can be produced in a flexible manner with an extremely high level of dimensional accuracy. In this manner, the contour of the receiving arrangement for a gear wheel can be embodied by suitably cutting the lamellae in a flexible and simple manner.

The ring having the rotor poles and the rotor hub can comprise axially extending grooves that complement one another wherein in each case a groove on the pole ring and a groove on the rotor hub together receive a connecting pin. The connecting pins secure the pole ring to the hub in a rotatably fixed manner. The hub, as is further explained hereinunder, can be composed of two hub disks that extend in each case over half of the axial extension of the hub.

If the gear mechanism that is integrated into the rotor is a differential gear, the rotor can comprise recesses in which the compensating gear wheels of the differential gear are mounted. These recesses can be arranged in particular in the hub of the rotor. In this manner, the rotor and/or the rotor hub itself forms the differential cage of the differential gear. The compensating gear wheels can be embodied in such a manner that they are arranged in the rotor in pairs in recesses that are adjacent to one another. The center points of the recesses lie on a common circle about the rotor axis. Two adjacent recesses lie with respect to one another in such a manner that the teeth of the compensating gear wheels that are mounted therein mesh with one another. The first recess extends from the axial center of the rotor towards one end. The second recess extends from the axial center of the rotor towards the opposite lying end. The mutually facing front face ends of the compensating gear wheels extend over a particular stretch in parallel with one another and comprise the gears that mesh with one another. The ends of the compensating gear wheels that lie external to the rotor center are coupled to the output side that leads to the vehicle wheels in the case of a vehicle drive.

As mentioned, the hub of the rotor can be composed of two axially opposite lying disks. The first compensating gear wheel of a compensating gear wheel pair can extend for the most part in the first disk of the rotor hub. The second compensating gear wheel of a compensating gear wheel pair can for the most part be received in the second disk of the rotor hub. The part that meshes with the teeth of the respective other compensating gear wheel extends into the respective other disk of the rotor hub.

It is preferred that the hub of the rotor is manufactured from a light alloy. This achieves a considerable weight reduction in comparison to using the iron material of the poles. The light alloy hub can be cast or machined. The disks of the hub can also be formed from cast blanks that are machined in order to provide for the bearing seats.

The outer-lying front face ends of the compensating gear wheels are preferably coupled on the output side to a reduction gear. The reduction gear can in particular be a planetary gear mechanism. The planetary gear mechanism can comprise a sun gear wheel, wherein in a practical embodiment the compensating gear wheels can mesh with the sun gear wheel. The sun gear wheel can comprise a circumferential groove, in which a seal is received.

In addition, the planetary gear mechanism can comprise a planetary carrier having planet gear wheels wherein the planetary carrier is connected to an output shaft. The planetary carrier carries the planet gear wheels that mesh with the sun gear wheel. The planet gear wheels mesh with a ring gear wheel on their exterior side. The ring gear wheel can preferably be securely coupled to an exterior housing that is rotatably fixed in relation to the stator. In particular, the sun gear wheel can be arranged on a sleeve-shaped fastening element that can be coupled to an exterior housing of the geared motor.

The geared motor can be embodied in a symmetrical manner to form a vehicle drive. A planetary gear mechanism can be provided in each case on the two front faces of the rotor, wherein the first compensating gear wheel of a compensating gear wheel pair meshes with the sun gear wheel of the first planetary gear mechanism and the second compensating gear wheel of a compensating gear wheel pair meshes with the sun gear wheel of the second planetary gear mechanism. The two planetary carriers of the planetary gear mechanism can be connected in each case to an output shaft that drives in each case a drive wheel. Any rotation speed differences between the drive wheels whilst negotiating curves can be compensated for by means of the integrated differential gear. The two planetary gear mechanisms that have an identical reduction gear ratio reduce the rotor rotation speed down to the rotation speed of the drive wheels.

An embodiment of the invention is described hereinunder with reference to the attached drawings.

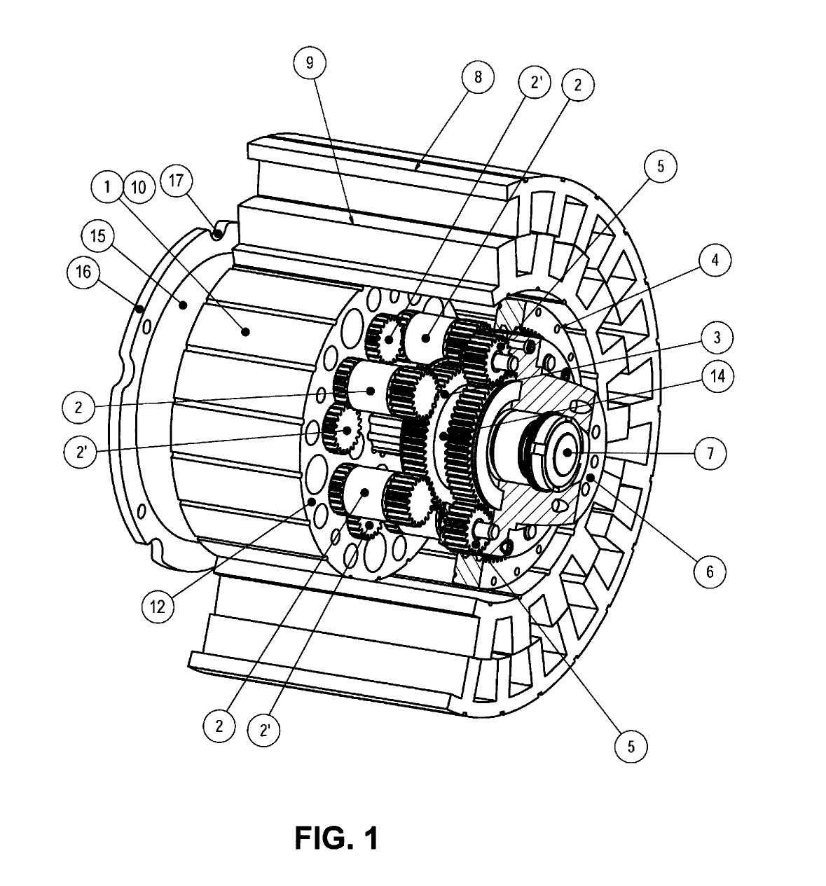

FIG. 1 illustrates a partially cut-away, three dimensional illustration of essential components of the geared motor as claimed in the invention.

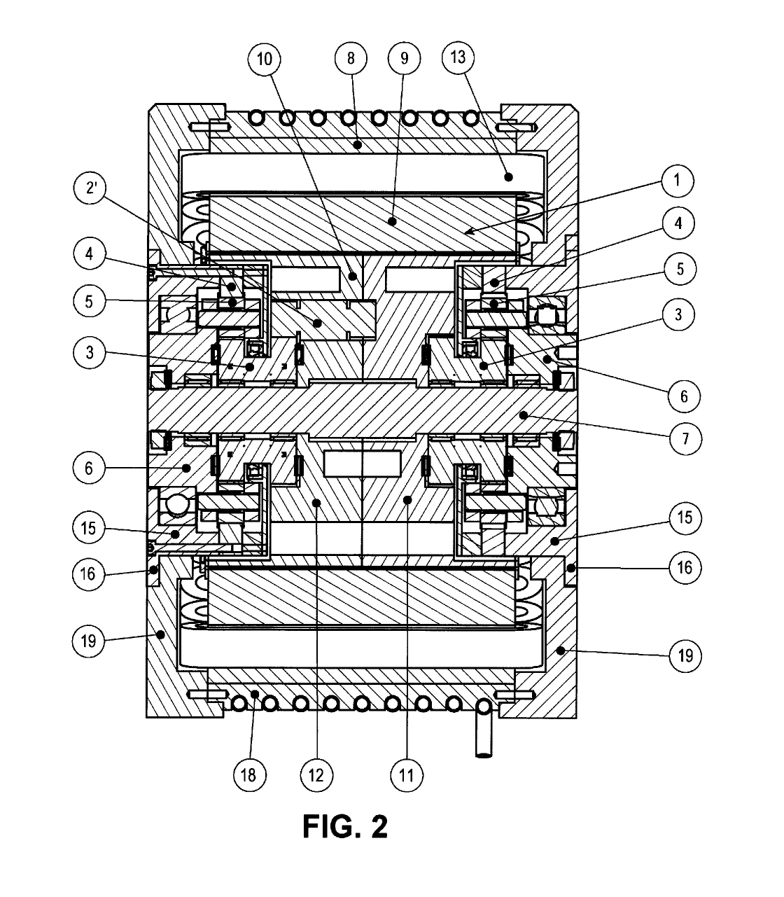

FIG. 2 illustrates a longitudinal sectional view of the geared motor in FIG. 1 with a housing.

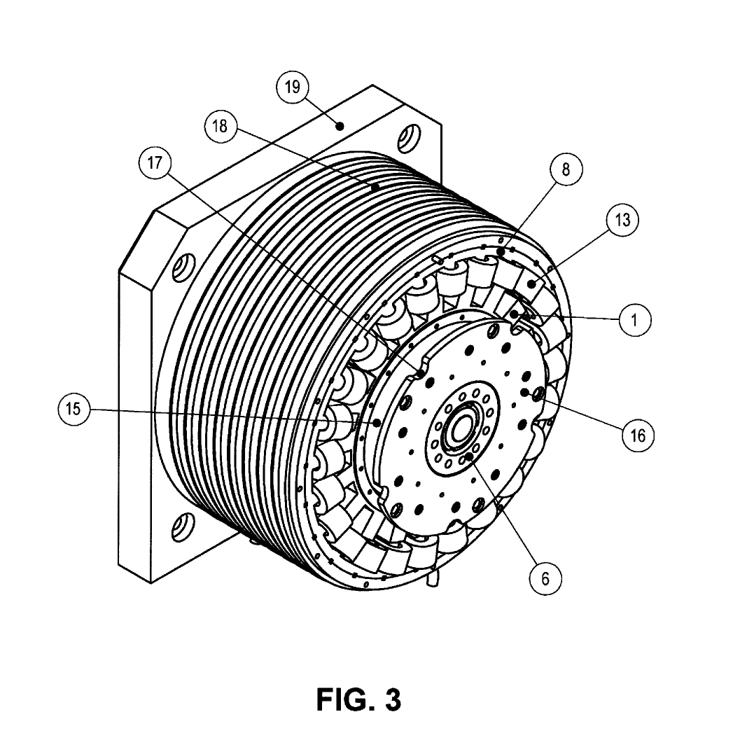

FIG. 3 illustrates a three dimensional illustration of the geared motor in FIGS. 1 and 2.

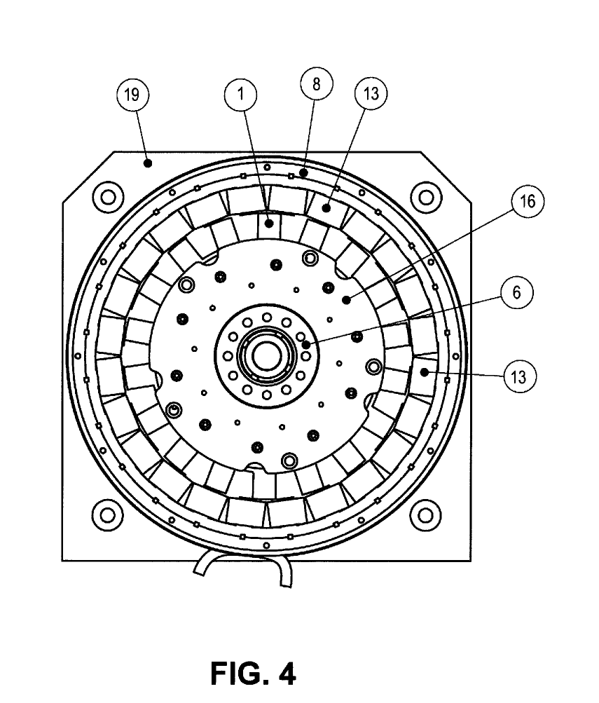

FIG. 4 illustrates an end view of the geared motor in FIGS. 1 to 3.

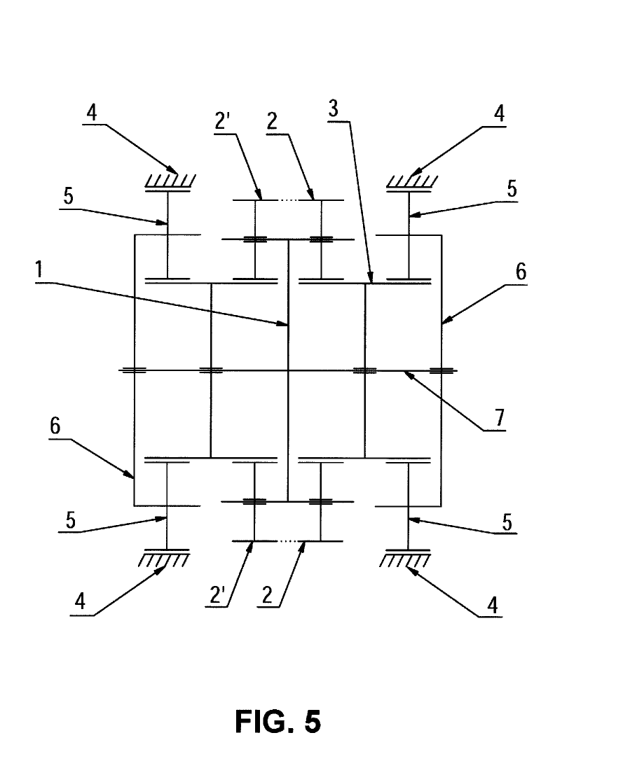

FIG. 5 illustrates a schematic drawing of the gear mechanism of the geared motor in FIGS. 1 to 3.

The geared motor that is illustrated in the drawings consists essentially of a stator 8 and a rotor 1. The stator 8 comprises twenty-four poles that are surrounded by the windings 13. The windings 13 of the stator 8 are only illustrated in FIGS. 3 and 4 and for reasons of clarity are not illustrated in the other figures. The stator 8 is formed by an annular or cylinder sleeve-shaped component that is formed from individual, mutually connected annular disks formed as lamellae. As a consequence, eddy currents in the poles and in the stator 8 are reduced or avoided. The stator 8 is connected in a rotatably fixed manner to a housing 18 (cf. FIG. 2 or 3) of the geared motor. In the illustrated embodiment, the stator 8 comprises twenty-four poles that are consolidated into four pole groups each having six poles. The spacing between the individual poles consequently amounts in each case to 15°, wherein poles of the same group follow in succession with a spacing of 60°.

The rotor 1 comprises eighteen poles that are not surrounded by windings. As a pole group of the stator is excited, the rotor 1 is moved into a position that comprises the lowest magnetic resistance (reluctance), in other words, in which position, the mutually opposite lying front faces of the excited stator pole and the nearest rotor pole are aligned as much as possible.

The poles of the rotor 1 are formed by a pole ring 9 that likewise has an annular shaped cross section and is embodied in a cylinder sleeve-shaped manner. The pole ring 9 of the rotor is also formed from individual, mutually connected lamellae. A hub 10 that is manufactured from light alloy is arranged in the pole ring 9. The hub 10 is formed by two hub disks 11 and 12. The hub disks 11 and 12 extend in each case over half of the axial length of the rotor 1. Only the left-hand hub disk 12 is illustrated in the FIG. 1 for describing the gear mechanism function and the right-hand hub disk 11 is omitted so that the gear wheels of the gear mechanism are visible.

The hub disks 11, 12 comprise recesses in which the compensating gear wheels 2, 2′ of the differential gear are mounted. The compensating gear wheels 2, 2′ are embodied in a cylindrical manner and comprise teeth on their front face ends, which teeth form a spur-gear differential or straight differential. In each case, two compensating gear wheels 2, 2′ form a compensating gear wheel pair whose toothed sections mesh with one another in the region of the axial center of the hub 10. The compensating gear wheels 2, 2′ are mounted within the respective hub disks 11 and/or 12 between the front face, toothed sections. The toothed sections of the compensating gear wheels 2, 2′ that lie in the external regions of the rotor 1 mesh with a sun gear wheel 3 of a planetary gear mechanism. The outer lying toothed sections of the right-hand compensating gear wheels 2 mesh in the right-hand hub disk 11 with the sun gear wheel 3 of the right-hand planetary gear mechanism. The outer lying toothed sections of the other compensating wheels 2′ of the compensating gear wheel pairs that are remote from the center of the rotor 1 mesh with the left-hand sun gear wheel 3 of the left-hand planetary gear mechanism. Although one compensating gear wheel pair would suffice in order to fulfill the function of the differential gear, in total five compensating gear wheel pairs are provided in the illustrated embodiment. The maximum forces and torque that can be absorbed by the toothing arrangement of the compensating wheel pairs are combined so that in the case of five compensating wheel pairs a large torque can be transferred from the motor to the drive wheels. Each of the sun gear wheels 3 comprises a groove 14 that receives a seal. The toothed region of the sun gear wheel 3 that lies outside the groove 14 meshes with the planet gear wheels 5. In each case, three planet gear wheels 5 are arranged on a common planetary carrier 6, onto which an output shaft (not illustrated) can be fastened. A ring gear wheel 4 of the planetary gear mechanism is arranged fixed in position with respect to the stator 8. For this purpose, the ring gear wheel 4 is fastened to a sleeve-shaped fastening element 15 that protrudes parallel to the motor shaft 7 from the rotor 1. In particular, it is evident in FIG. 1 that the sleeve-shaped fastening element 15 comprises a connecting flange 16 that comprises recesses 17 on its circumference. The recesses 17 cooperate with protrusions on the cover 19 of a housing 18 of the geared motor (cf. FIG. 2). The housing 18 is fixed with respect to the stator 8 and clamps the ring gear wheel 4. Only the rear housing cover 19 is illustrated in each case in the FIGS. 3 and 4. The front housing covers are not illustrated so that the rotor poles and the stator poles having their windings 13 are visible.

The geared motor in accordance with the invention forms a compact component that reduces the relatively high drive rotation speed of a switched reluctance motor to the relatively low rotation speed of the drive wheels of a vehicle. For this purpose, the two reduction gears embodied as planetary gear mechanisms are provided, which reduction gears are located in the rotor 1 near to its front face ends. In addition, the compensating gear wheels 2, 2′ in the rotor disks 11, 12 form a differential gear that can compensate for different rotation speeds between the drive wheels. The geared motor consequently forms an optimal component that can be integrated into the vehicle construction for driving an electric vehicle.

In the case of the illustrated embodiment, all gear mechanism elements are mounted in the hub 10 of the rotor. It is however also feasible for the pole wheel that is formed from annular shaped lamellae to be allowed to protrude radially further inwards into the rotor. In this case, gear wheels could also be at least in part mounted in receiving arrangements that are arranged in the pole wheel. If the contours of the lamellae are produced by means of laser cutting, then profiles of the lamellae that are necessary for forming the receiving arrangements can be produced in flexible and cost-effective manner.

FIG. 5 illustrates a schematic gear circuit diagram of the geared motor. In this case, it is noted that the rotor is described by the numeral 1, which rotor comprises the bearings for the compensating gear wheels of a pair, which compensating gear wheels are described by the numerals 2 and 2′. In FIG. 5, two pairs of compensating gear wheels 2, 2′ are illustrated. The coupling of the compensating gear wheels 2 and 2′ of a compensating gear wheel pair is implemented in such a manner that the compensating gear wheels counter rotate by virtue of the fact that the toothed sections of the compensating gear wheels 2 and 2′ mesh with one another in the region of the center of the rotor hub. This is illustrated by means of the dashed illustrated coupling line on the outer face (remote from the motor shaft) between the two compensating gear wheels 2 and 2′ of a pair.

### List of Reference Numerals

1 Rotor
2 Compensating Gear Wheel
2′ Compensating Gear Wheel
3 Sun Gear wheel
4 Ring Gear wheel
5 Planet Gear wheel
6 Planetary Carrier
7 Motor Shaft
8 Stator
9 Pole Ring of the Rotor
10 Hub
11 Hub Disk
12 Hub Disk
13 Winding
14 Groove
15 Sleeve-Shaped Fastening Element
16 Connecting Flange
17 Recesses
18 Housing
19 Housing Cover

1. A geared motor, comprising:
a rotor;
a stator that surrounds the rotor; and
a gear mechanism having gear wheels, wherein the gear wheels of the gear mechanism are arranged at least in part in the rotor.

2. The geared motor as claimed in claim 1, further comprising:
a switched reluctance motor.

3. The geared motor as claimed in claim 1, further comprising at least one of the following features:
the rotor includes a number of poles that are arranged in an annular manner;
the poles of the rotor are formed by a closed ring that is embodied from lamellae that are connected to one another;
the closed ring surrounds a hub;
the closed ring is connected to the hub in a positive locking manner; or
the gear wheels of the gear mechanism are mounted in at least one of: the hub or the closed ring.

4. The geared motor as claimed in claim 1, wherein the gear mechanism includes at least one differential gear.

5. The geared motor as claimed in claim 4, wherein the rotor includes recesses, and wherein compensating gear wheels of the differential gear are mounted in the recesses.

6. The geared motor as claimed in claim 5, wherein the recesses are arranged in a hub.

7. The geared motor as claimed in claim 5, wherein the rotor includes at least one pair of recesses that are adjacent to one another, and wherein a pair of compensating gear wheels, are mounted in the recesses, and wherein the pair of compensating gear wheels mesh with one another at a first axial position and at a second axial position and are coupled in each case to an output.

8. The geared motor as claimed in claim 7, further comprising:
a hub composed of two disks, wherein a largest part of a first compensating gear wheel of the pair of compensating gear wheels is received in the first disk and a largest part of a second compensating gear wheel (2′) of the pair of compensating gear wheels is received in the second disk.

9. The geared motor as claimed in claim 8, wherein the hub is manufactured from a light alloy.

10. The geared motor as claimed in claim 1, wherein the gear mechanism includes at least one reduction gear.

11-15. (canceled)

16. The geared motor as claimed in claim 10, wherein the gear mechanism includes a planetary gear mechanism.

17. The geared motor as claimed in claim 16, wherein the planetary gear mechanism includes a sun gear wheel, and wherein the gear wheels are compensating gear wheels that mesh with the sun gear wheel.

18. The geared motor as claimed in claim 17, wherein the sun gear wheel includes a groove that extends in a circumferential direction for receiving a sealing arrangement.

19. The geared motor as claimed in claim 16, wherein the planetary gear mechanism includes a planetary carrier having planet gear wheels, and wherein the planetary carrier is coupled to an output shaft.

20. The geared motor as claimed in claim 19, wherein the planetary gear mechanism includes a ring gear wheel that is connected in a rotably-fixed manner to an exterior housing that is fixedly connected to the stator.

21. The geared motor as claimed in any claim 16, wherein the planetary gear mechanism is a first planetary gear mechanism that is provided on two front faces of the rotor, wherein a first compensating gear wheel of a pair meshes with a sun gear wheel of the first planetary gear mechanism, and wherein a second compensating gear wheel of a pair meshes with a sun gear wheel of a second planetary gear mechanism.

22. The geared motor as claimed in claim 1, wherein the rotor includes a number of poles that are arranged in an annular manner, wherein the poles of the rotor are formed by a closed ring that is embodied from lamellae that are connected to one another, wherein the closed ring surrounds a hub and is connected to the hub in a positive locking manner, and wherein the gear wheels of the gear mechanism are mounted in at least one of: the hub or the closed ring.
